(19) United States
(12) Patent Application Publication
(10) Pub. No.: US 2026/0067825 A1
(43) Pub. Date: Mar. 5, 2026

(54) IN-VEHICLE NETWORK SYSTEM AND CONTROL METHOD FOR IN-VEHICLE NETWORK SYSTEM

(71) Applicant: DENSO CORPORATION, Kariya-city (JP)

(72) Inventors: Sho MATSUMOTO, Kariya-city (JP); Tomohisa KISHIGAMI, Kariya-city (JP)

(21) Appl. No.: 19/283,702

(22) Filed: Jul. 29, 2025

(30) Foreign Application Priority Data
Sep. 5, 2024 (JP) 2024-153408

(51) Int. Cl. H04W 52/02; H04W 4/48

(52) U.S. Cl. CPC H04W 52/028; H04W 4/48

(57) ABSTRACT

An in-vehicle network system includes control devices connected to a communication bus and capable of communicating with each other in a vehicle. The control devices include at least one upper control device and lower control devices. The upper control device includes: a power management unit that turns on and off relay circuits provided in a power supply line of each of the lower control devices; and a startup management unit that receives, on behalf of the lower control devices, a network management message that selectively instructs a startup of the lower control devices transmitted via the communication bus, and instructs the power management unit to turn on a relay circuit provided in the power supply line of the lower control device instructed to start by the network management message, to bring the lower control device instructed to start into a startup state.

### CROSS REFERENCE TO RELATED APPLICATION

This application is based on Japanese Patent Application No. 2024-153408 filed on September 5, 2024, the disclosure of which is incorporated herein by reference.

### TECHNICAL FIELD

The present disclosure relates to an in-vehicle network system having a plurality of control devices connected to a communication bus and capable of mutual communication, and a control method for the in-vehicle network system.

### BACKGROUND

A related art discloses an in-vehicle network system including an upper ECU, an intermediate ECU, and a lower ECU. In the in-vehicle network system of the related art, the intermediate ECU is supplied with power from a power source and supplies power from the power source to the lower ECU in response to a message received from the upper ECU. In other words, the intermediate ECU maintains the lower ECU in a power-off state until a message is received from the upper ECU. When the intermediate ECU receives a message from the upper ECU, the lower ECU is supplied with power from the power source. The lower ECU transitions from the power-off state to a standby state awaiting instructions due to the power supply.

### SUMMARY

According to an aspect of the present disclosure, an in-vehicle network system includes a plurality of control devices connected to a communication bus and capable of communicating with each other in a vehicle. The plurality of control devices may include at least one upper control device and a plurality of lower control devices. the upper control device may include: a power management unit that turns on and off a plurality of relay circuits provided in a power supply line of each of the plurality of lower control devices; and a startup management unit that receives, on behalf of the plurality of lower control devices, a network management message (NM message) that selectively instructs a startup of the plurality of lower control devices transmitted via the communication bus, and instructs the power management unit to turn on a relay circuit provided in the power supply line of the lower control device instructed to start by the NM message, to bring the lower control device instructed to start into a startup state.

### BRIEF DESCRIPTION OF DRAWINGS

Objects, features and advantages of the present disclosure will become more apparent from the following detailed description made with reference to the accompanying drawings. In the drawings:

FIG. 1 is a configuration diagram showing an example of the configuration of the in-vehicle network system according to the first embodiment;

FIG. 2 is an explanatory diagram for explaining an example of an NM message, PN request information, and PNC configuration information;

FIG. 3 is a diagram showing an example of a PNC configuration table stored in the storage unit of the power/startup management ECU;

FIG. 4 is a diagram showing an example of relay connection information stored in the storage unit of the power/startup management ECU;

FIG. 5 is a flowchart showing the process executed in the power/startup management ECU to subject the first and second lower ECUs to partial networking in response to an NM message in the first embodiment;

FIG. 6 is a flowchart showing the details of the startup ECU identification process in the flowchart of FIG. 5;

FIG. 7 is a flowchart showing the process executed in the power/startup management ECU to subject the first and second lower ECUs to partial networking in response to an NM message in the second embodiment;

FIG. 8 is a sequence diagram showing the processing sequence by the process shown in the flowchart of FIG. 7; and

FIG. 9 is a configuration diagram showing an example of the configuration of the in-vehicle network system according to the third embodiment.

### DETAILED DESCRIPTION

In the in-vehicle network system described in a related art, the lower ECU is maintained in a power-off state until the intermediate ECU receives a message from the upper ECU. Therefore, compared to merely putting the lower ECU in a standby state (also referred to as sleep state), the power consumption of the lower ECU can be reduced.

However, in the in-vehicle network system described in a related art, the intermediate ECU is configured to supply power from the power source to all lower ECU s when it receives a message from the upper ECU. In other words, multiple lower ECUs connected to the intermediate ECU always have their power supply and shutdown managed simultaneously.

Thus, when the relationship between the intermediate ECU managing the power supply and shutdown and the managed lower ECUs is fixed, it becomes difficult to finely manage the power supply and shutdown of the lower ECUs. For example, when setting a cluster, which is a group of ECUs that start simultaneously to achieve a desired function, at least one ECU may belong to multiple clusters. However, in the in-vehicle network system of a related art, it is difficult to meet such a requirement because a single lower ECU cannot be power-managed by two or more intermediate ECUs.

The present disclosure has been made in view of the above points, and aims to provide an in-vehicle network system and a control method for the in-vehicle network system that can finely manage the power supply and shutdown to the lower control devices while being configured to switch the power supply to the lower control devices from a power-off state to a power-on state in response to a message requesting startup.

According to an aspect of the present disclosure, an in-vehicle network system includes: a plurality of control devices connected to a communication bus and capable of communicating with each other in a vehicle. The plurality of control devices include at least one upper control device and a plurality of lower control devices. The upper control device includes: a power management unit that turns on and off a plurality of relay circuits provided in a power supply line of each of the plurality of lower control devices; and a startup management unit that receives, on behalf of the plurality of lower control devices, a network management message (NM message) that selectively instructs a startup of the plurality of lower control devices transmitted via the communication bus, and instructs the power management unit to turn on a relay circuit provided in the power supply line of the lower control device instructed to start by the NM message, to bring the lower control device instructed to start into a startup state.

According to an aspect of the present disclosure, a control method for an in-vehicle network system including a plurality of control devices connected to a communication bus and capable of communicating with each other in a vehicle is provided. The plurality of control devices include at least one upper control device and a plurality of lower control devices. The upper control device includes a power management unit that turns on and off a plurality of relay circuits provided in a power supply line of each of the plurality of lower control devices. The method includes: receiving, by the upper control device, on behalf of the plurality of lower control devices, a network management message (NM message) that selectively instructs a startup of the plurality of lower control devices transmitted via the communication bus; and bringing the lower control device instructed to start into a startup state by turning on the relay circuit provided in the power supply line of the lower control device instructed to start by the NM message.

According to the in-vehicle network system and the control method for the in-vehicle network system of the present disclosure, the upper control device receives the NM message, which selectively instructs the startup of the plurality of lower control devices, on behalf of the plurality of lower control devices via the communication bus. Then, the upper control device turns on the relay circuits provided in the power supply line of the lower control devices indicated by the NM message to switch the indicated lower control devices to the startup state.

Therefore, according to the in-vehicle network system and the control method for the in-vehicle network system of the present disclosure, it is possible to finely manage the power supply and shutdown to the lower control devices while being configured to switch the power supply to the lower control devices from a power-off state to a power-on state in response to NM message instructing startup.

Embodiments of the in-vehicle network system and the control method for the in-vehicle network system according to the present disclosure will be described with reference to the drawings. However, the present disclosure is not limited to the following embodiments, and various modifications described later are also included within the technical scope of the present disclosure. Furthermore, various changes can be made within the scope that does not deviate from the gist of the present disclosure. The embodiments and various modifications can be appropriately combined as long as no technical contradictions arise. In the following description, the same or similar configurations may be denoted by the same reference numbers across multiple drawings, and explanations may be omitted. Additionally, when referring to only a part of the configuration, the description of other parts can be applied from other sections.

### First Embodiment

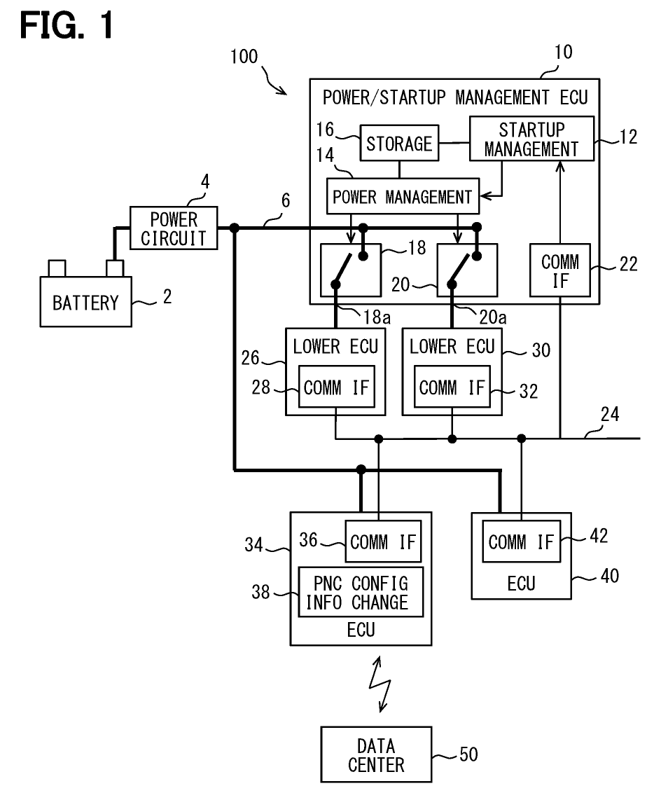

FIG. 1 is a configuration diagram showing an example of the configuration of the in-vehicle network system 100 according to the present embodiment. As shown in FIG. 1, the in-vehicle network system 100 includes a power/startup management ECU 10 as an upper control device, first and second lower ECUs 26, 30 as lower control devices, and first and second normal ECUs 34, 40. ECU stands for Electronic Control Unit.

The number of first and second lower ECUs 26, 30 connected to the power/startup management ECU 10 via first and second relay circuits 18, 20, respectively, is not limited to two and may be three or more. Additionally, the number of first and second lower ECUs 26, 30 connected to each of the first and second relay circuits 18, 20 is not limited to one and may be two or more. Furthermore, within the vehicle, the combination of the power/startup management ECU 10 and the first and second lower ECUs 26, 30 may be provided in multiple sets. When multiple sets of the power/startup management ECU 10 and the first and second lower ECUs 26, 30 are provided in the vehicle, each power/startup management ECU 10 and the first and second lower ECUs 26, 30 can be connected to communicate with each other via the communication bus 24.

The power/startup management ECU 10, first and second lower ECUs 26, 30, and first and second normal ECUs 34, 40 can each be constituted by a computer including a processor, memory, and storage. The power/startup management ECU 10, first and second lower ECUs 26, 30, and first and second normal ECUs 34, 40 also include communication interfaces (communication IF) 22, 28, 32, 36, 42 for communicating with other ECUs.

The processor may be, for example, a CPU, MPU, GPU, DFP, or the like that executes predetermined processing or instructions according to a program. The memory is a volatile storage medium, such as RAM, that temporarily stores the processing results of the processor. The storage is a non-volatile storage medium, such as flash memory or ROM. Various programs and data executed by the processor are stored in the storage. The functions of the power/startup management ECU 10, first and second lower ECUs 26, 30, and first and second normal ECUs 34, 40 can be realized by hardware, such as an ASIC (Application Specific Integrated Circuit) or FPGA (Field-Programmable Gate Array), instead of software.

The power/startup management ECU 10 can function as a domain controller that oversees the control of the first and second lower ECUs 26, 30. A domain refers to a functional unit when broadly dividing the functions of a vehicle, such as the powertrain domain, chassis domain, advanced driver assistance domain, body domain, and cockpit domain. The above is an example of domain classification, and the classification may differ from the example mentioned. Additionally, the power/startup management ECU 10 may function as an area controller that oversees the control of the lower ECUs 26, 30 arranged in each area of the vehicle.

The in-vehicle network system 100 can use CAN (registered trademark) as the communication protocol for mutual communication between the ECUs 10, 26, 30, 34, 40. The communication protocol is not limited to CAN, and the in-vehicle network system 100 may adopt another communication protocol, such as CAN-FD. However, in the in-vehicle network system 100 of the present embodiment, the first and second lower ECUs 26, 30, and the first and second normal ECUs 34, 40 are divided into multiple groups (referred to as clusters) for each ECU that needs to be started simultaneously to achieve at least one desired function. Using the network management message (NM message) described later, the normal operation mode (startup state) and the power-saving mode (e.g., sleep state) are switched for each cluster. The power-saving mode includes the power-off state of the first and second lower ECUs 26, 30. Therefore, the communication protocol adopted by the in-vehicle network system 100 needs to support the transmission and reception of NM messages.

The first and second lower ECUs 26, 30, and the first and second normal ECUs 34, 40 are, for example, control ECUs for controlling predetermined control targets in the vehicle or sensor ECUs for calculating predetermined physical quantities based on detection signals detected by sensors. The first and second lower ECUs 26, 30, and the first and second normal ECUs 34, 40 enter the startup state in the normal operation mode and execute normal operations when it is necessary to control the control targets or calculate predetermined physical quantities based on the detection signals from the sensors. On the other hand, the first and second lower ECUs 26, 30, and the first and second normal ECUs 34, 40 enter the power-saving mode and switch to the power-off state or sleep state when it is not necessary to control the control targets or calculate the predetermined physical quantities.

To switch between the startup state and the power-off state or sleep state, the first and second lower ECUs 26, 30, and the first and second normal ECUs 34, 40 are each assigned to a cluster among the multiple divided clusters. The assigned cluster is retained as cluster configuration information (also referred to as PNC configuration information) in each ECU. However, the PNC configuration information of the first and second lower ECUs 26, 30 is stored in the storage unit 16 of the power/startup management ECU 10, as described later. The first and second lower ECUs 26, 30, and the first and second normal ECUs 34, 40 are configured to switch from the power-off state or sleep state to the startup state in response to the startup cluster information (also referred to as PN request information) included in the NM message, which requests the startup of the cluster to which each ECU belongs.

The first and second lower ECUs 26, 30, and the first and second normal ECUs 34, 40 periodically transmit NM messages to other ECUs while in the startup state and normal operation mode. When the first and second lower ECUs 26, 30, and the first and second normal ECUs 34, 40 no longer need to perform normal operations, they stop transmitting the periodic NM messages. The first and second normal ECUs 34, 40 switch from the normal operation mode to the power-saving mode and switch from the startup state to the sleep state when the time without receiving NM messages from other ECUs belonging to the same cluster reaches a predetermined standby time. For the first and second lower ECUs 26, 30, the power/startup management ECU 10 monitors the NM messages directed to the first and second lower ECUs 26, 30. When the time without receiving NM messages directed to the first and second lower ECUs 26, 30 reaches a predetermined standby time, the power/startup management ECU 10 turns off the first and second relay circuits 18, 20 to stop the power supply to the first and second lower ECUs 26, 30.

The first and second normal ECUs 34, 40 have communication IFs 36, 42 capable of receiving NM messages and switching the first and second normal ECUs 34, 40 from the sleep state to the startup state in response to receiving NM messages. When switched to the startup state by the communication IFs 36, 42, the first and second normal ECUs 34, 40 determine whether their startup is requested based on the PN request information and PNC configuration information of the NM message. If it is determined that their startup is requested, the first and second normal ECUs 34, 40 continue in the startup state. If it is determined that their startup is not requested, the first and second normal ECUs 34, 40 return to the sleep state. The determination based on the PN request information and PNC configuration information of the NM message may be executed by the communication IFs 36, 42. In this case, if the communication IF determines that the startup is requested based on the PN request information and PNC configuration information, it transitions the corresponding ECU from the sleep state to the startup state. Hereinafter, an example of the NM message, PN request information, and PNC configuration information will be described in detail.

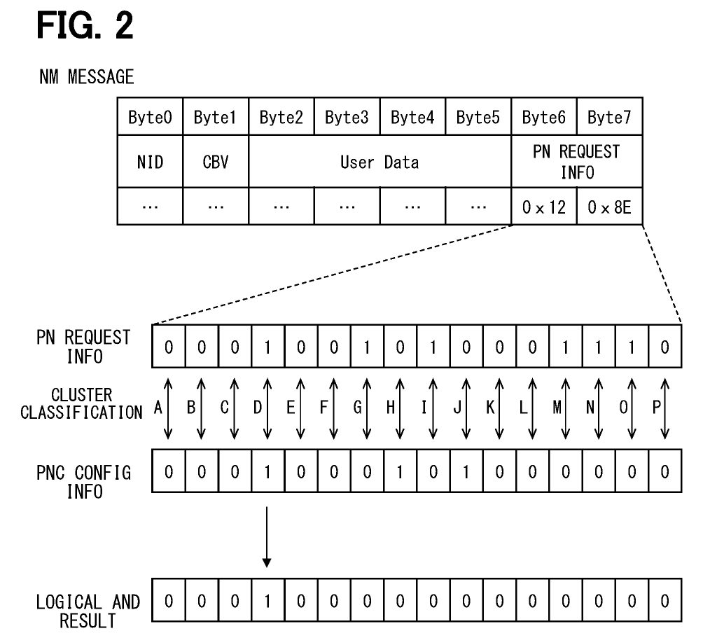

As shown in FIG. 2, the NM message includes data from byte 0 to byte 7. Byte 0 includes the node ID (NID). The node ID is a unique identifier for each of the power/startup management ECU 10, first and second lower ECUs 26, 30, and first and second normal ECUs 34, 40. The node ID can identify the sender (that is, transmission source) of the NM message. Byte 1 includes the control bit vector (CBV). The control bit vector is data indicating whether partial networking is used. If the control bit vector indicates the use of partial networking, the user data area from byte 2 to byte 7 includes PN request information, which is startup cluster information indicating the cluster to be started. Partial networking means that only the ECUs belonging to some clusters are in the startup state, while the ECUs belonging to the remaining clusters are in the power-off state or sleep state. By keeping only the ECUs that need to operate in the startup state, the power consumption by each ECU installed in the vehicle can be reduced.

In the example shown in FIG. 2, the control bit vector indicates the use of partial networking, and the PN request information is stored in bytes 6 and 7 of the user data area. The user data area from byte 2 to byte 5 can be used to transmit arbitrary information, such as ECU startup factors or information regarding normal or abnormal conditions. Here, FIG. 2 is merely an example of the format of an NM message, and the NM message may have other formats as long as it includes the indication of the use of partial networking and the PN request information.

The PN request information indicates which clusters among the multiple divided clusters need to be started and which clusters do not need to be started. More specifically, in the example shown in FIG. 2, the clusters are pre-divided into 16. The PN request information includes 16-bit data corresponding to the 16 divided clusters. That is, the 16-bit data of the PN request information is pre-associated with the 16 divided clusters. Each bit of the 16-bit data in the PN request information indicates whether the startup of the associated cluster is necessary: "0" indicates that the startup of the associated cluster is not necessary, while "1" indicates that the startup of the associated cluster is necessary.

The first and second lower ECUs 26, 30, and the first and second normal ECUs 34, 40 have PNC configuration information indicating the clusters to which they belong among the multiple divided clusters, as described above. An example of this PNC configuration information is shown in FIG. 2. FIG. 2 shows an example of PNC configuration information held by any one of the first and second lower ECUs 26, 30, and the first and second normal ECUs 34, 40. In the PNC configuration information shown in FIG. 2, if the clusters are classified as “A” to “P”, the PNC configuration information indicates that the ECU holding this PNC configuration information belongs to clusters D, H, and J. The first and second lower ECUs 26, 30, and the first and second normal ECUs 34, 40 can belong to one or more clusters because they can perform various functions by executing programs.

When the first and second normal ECUs 34, 40 receive an NM message containing PN request information via their respective communication IFs 36, 42, they compare the PN request information with the PNC configuration information bit by bit, for example, by calculating the logical AND. That is, when the NM message is received by the communication IFs 36, 42 of the first and second normal ECUs 34, 40, they temporarily enter the startup state. Then, the first and second normal ECUs 34, 40 determine whether the clusters requested to be started by the PN request information included in the NM message match the clusters assigned to them by the PNC configuration information. For example, in the example shown in FIG. 2, the clusters requested to be started by the PN request information are clusters D, G, I, M, N, and O. The clusters to which the ECU belongs, as indicated by the PNC configuration information, are clusters D, H, and J. In this case, the clusters requested to be started by the PN request information included in the NM message and the clusters of the PNC configuration information match in cluster D. Therefore, as shown in FIG. 2, the result of the logical AND is "1" for cluster D.

If any bit of the logical AND result is "1," the ECU with the PNC configuration information shown in FIG. 2 determines that its startup is requested. Based on this determination result, the ECU with the PNC configuration information shown in FIG. 2 transitions from the sleep state to the startup state or maintains the startup state if it is already in the startup state. On the other hand, if none of the bits of the logical AND result is "1" and all are "0," the ECU with the PNC configuration information shown in FIG. 2 determines that its startup is not requested. In this case, the ECU with the PNC configuration information shown in FIG. 2 discards the received NM message and returns to the sleep state.

Thus, the first and second normal ECUs 34, 40 have the function of identifying whether the NM message requests their startup based on the PNC configuration information. This function of identifying the NM message ensures that only the first and second normal ECUs 34, 40 with PNC configuration information that includes the clusters requested to be started by the PN request information enter the startup state in response to the NM message. Hereinafter, a communication IF with the function of receiving NM messages and switching the ECU from the sleep state to the startup state in the sleep state of the ECU will be referred to as an NM-compatible communication IF.

In the in-vehicle network system 100 according to the present embodiment, the first and second lower ECUs 26, 30 do not have NM-compatible communication IFs. In other words, the communication IFs 28, 32 of the first and second lower ECUs 26, 30 are both NM-incompatible communication IFs. As described above, the NM-compatible communication IF has the function of receiving NM messages and switching the ECU from the sleep state to the startup state in the sleep state of the ECU. Therefore, the NM-compatible communication IF is more expensive than the NM-incompatible communication IF. The communication IFs 28, 32 of the first and second lower ECUs 26, 30 are NM-incompatible communication IFs as described above. Therefore, by using the combination of the power/startup management ECU 10 and the lower ECUs 26, 30, the overall cost of the in-vehicle network system 100 can be reduced.

The in-vehicle network system 100 according to the present embodiment is characterized by the configuration of the power/startup management ECU 10 to enable the first and second lower ECUs 26, 30 to be subject to partial networking in response to NM messages, even though the communication IFs 28, 32 of the first and second lower ECUs 26, 30 are both NM-incompatible communication IFs. Hereinafter, the features of the in-vehicle network system 100 according to the present embodiment will be described in detail.

As shown in FIG. 1, the power/startup management ECU 10 includes a startup management unit 12, a power management unit 14, a storage unit 16, first and second relay circuits 18, 20, and a communication IF 22. The startup management unit 12 and the power management unit 14 are functional units constructed within the power/startup management ECU 10 by software and/or hardware. The storage unit 16 can be constituted by the storage of the power/startup management ECU 10.

The first and second relay circuits 18, 20 of the power/startup management ECU 10 are provided in the power supply line 6 for supplying power to the first and second lower ECUs 26, 30, respectively. The power circuit 4 can convert the power supply voltage of the battery 2 mounted on the vehicle to the operating voltage of the power/startup management ECU 10, the first and second lower ECUs 26, 30, and the first and second normal ECUs 34, 40 as needed. The power supply line 6 is supplied with voltage from the power circuit 4.

In the example shown in FIG. 1, the power line of the first lower ECU 26 is connected to the first power port 18a connected to the first relay circuit 18. Similarly, the power line of the second lower ECU 30 is connected to the second power port 20a connected to the second relay circuit 20.

The first and second relay circuits 18, 20 can be constituted by semiconductor switches such as MOSFETs or IGBTs. However, the first and second relay circuits 18, 20 may also be constituted by conventional mechanical relays instead of semiconductor switches. The first and second relay circuits 18, 20 may be provided inside the power/startup management ECU 10, as shown in FIG. 1, or outside the power/startup management ECU 10.

The communication IF 22 of the power/startup management ECU 10 is an NM-compatible communication IF capable of receiving NM messages. The communication IFs 28, 32 of the plurality of lower ECUs 26, 30 are NM-incompatible communication IFs, as described above. In this embodiment, the plurality of lower ECUs 26, 30 enter a power-off state in the power-saving mode when their operation is not necessary. Therefore, the communication IFs 28, 32 of the plurality of lower ECUs 26, 30 cannot receive NM messages when the corresponding lower ECUs 26, 30 are in the power-saving mode. Consequently, the communication IF 22 of the power/startup management ECU 10 receives NM messages that selectively instruct the startup of the plurality of lower ECUs 26, 30 on behalf of the communication IFs 28, 32 of the plurality of lower ECUs 26, 30. The NM messages received by the communication IF 22 are provided to the startup management unit 12.

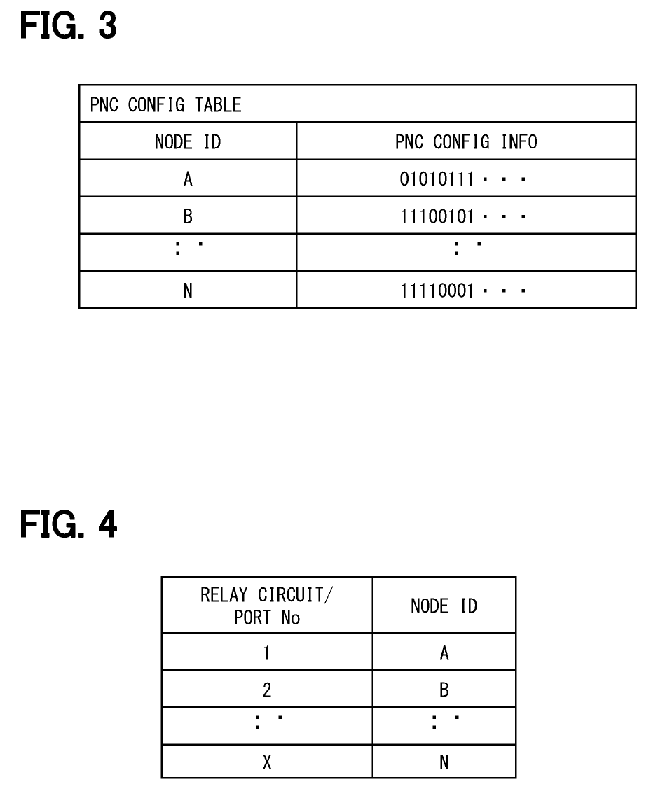

Here, the storage unit 16 of the power/startup management ECU 10 stores, in addition to programs executed by the processor of the power/startup management ECU 10, PNC configuration information indicating the clusters to which each of the first and second lower ECUs 26, 30 belongs, and relay connection information indicating the correspondence between the first and second relay circuits 18, 20 and the first and second lower ECUs 26, 30. For example, the storage unit 16 can store the PNC configuration information indicating the clusters assigned to each of the first and second lower ECUs 26, 30 using a PNC configuration table as shown in FIG. 3. The PNC configuration table illustrated in FIG. 3 shows the correspondence between the node IDs, which are unique identifiers of the plurality of lower ECUs including the first and second lower ECUs 26, 30, and the PNC configuration information assigned to the plurality of lower ECUs including the first and second lower ECUs 26, 30. Additionally, the storage unit 16 stores the relay connection information indicating the correspondence between the first and second relay circuits 18, 20 and the first and second lower ECUs 26, 30 as shown in FIG. 4. The relay connection information includes the numbers of the plurality of relay circuits, including the first and second relay circuits 18, 20, or the numbers of the power ports, and the node IDs indicating the unique identifiers of the plurality of lower ECUs, including the first and second lower ECUs 26, 30.

The startup management unit 12 of the power/startup management ECU 10 can obtain the PNC configuration information of each of the first and second lower ECUs 26, 30 by referring to the PNC configuration table illustrated in FIG. 3. The startup management unit 12 can determine which of the lower ECUs 26, 30 is instructed to start by the NM message based on the obtained PNC configuration information of each lower ECU 26, 30 and the PN request information of the NM message. Specifically, the startup management unit 12 compares the PN request information of the NM message with the PNC configuration information of each of the plurality of lower ECUs 26, 30 bit by bit. Based on the comparison result, if the startup management unit 12 determines that there is PNC configuration information including the cluster requested to be started by the PN request information, it determines that the startup of the lower ECUs 26, 30 corresponding to that PNC configuration information is instructed. In this case, the startup management unit 12 provides the node IDs of the lower ECUs 26, 30 instructed to start by the NM message to the power management unit 14. On the other hand, if the startup management unit 12 determines that there is no PNC configuration information including the cluster requested to be started by the PN request information, it discards the received NM message, as it does not instruct the startup of any of the lower ECUs 26, 30.

When the power management unit 14 of the power/startup management ECU 10 receives the node IDs of the lower ECUs 26, 30 instructed to start from the startup management unit 12, it refers to the relay connection information stored in the storage unit 16, which indicates the correspondence between each relay circuit 18, 20 and each lower ECU 26, 30. The power management unit 14 then identifies the relay circuits 18, 20 corresponding to the node IDs of the lower ECUs 26, 30 instructed to start and outputs drive signals to turn on the identified relay circuits 18, 20. As a result, power is supplied through the relay circuits 18, 20 corresponding to the lower ECUs 26, 30 instructed to start, and the corresponding lower ECUs 26, 30 enter the startup state.

The first and second lower ECUs 26, 30 control control target devices mounted on the vehicle that are controlled only when specific conditions are met or under specific environments (e.g., door lock mechanisms, power window drive motors, headlight light sources, wiper motors, AV equipment, etc.) or calculate predetermined physical quantities necessary for the control based on detection signals from sensors. For example, the door lock mechanism is controlled by an ECU for door lock control when the user of the vehicle attempts to get in or out of the vehicle. The power window drive motor is controlled by an ECU for power window control when the window lift switch is operated by the user.

Thus, the first and second lower ECUs 26, 30 control the control target devices that operate only when specific conditions are met or under specific environments, or calculate predetermined physical quantities necessary for such control. Therefore, when the startup of the first and second lower ECUs 26, 30 is instructed by an NM message, the power/startup management ECU 10 turns on the first and second relay circuits 18, 20 corresponding to the first and second lower ECUs 26, 30 to supply power to the first and second lower ECUs 26, 30. Conversely, when the startup of the first and second lower ECUs 26, 30 is not instructed by an NM message, the power/startup management ECU 10 turns off the first and second relay circuits 18, 20 corresponding to the first and second lower ECUs 26, 30 to stop the power supply to the first and second lower ECUs 26, 30. This allows for cutting off the dark current when the operation of each lower ECU 26, 30 is unnecessary, thereby achieving further power savings for the entire in-vehicle system.

The NM message can be generated by the power/startup management ECU 10 as a function of a domain controller or area controller. In this case, the power/startup management ECU 10 determines the functions to be executed in the vehicle and, when the execution of the desired function is necessary, generates an NM message containing PN request information that designates the cluster to be started as the startup cluster. The generated NM message is transmitted via the communication bus 24 to the first and second normal ECUs 34, 40 and other power/startup management ECUs 10. Furthermore, the generated NM message is also used to determine whether to switch the lower ECUs 26, 30 of the power/startup management ECU 10 itself to the startup state. However, the function of determining the functions to be executed in the vehicle and transmitting the NM message containing the PN request information may be possessed by other ECUs, such as the first and second normal ECUs 34, 40, instead of the power/startup management ECU 10.

Additionally, the power/startup management ECU 10 may enter the sleep state when all ECUs belonging to the in-vehicle network system 100 are in the sleep state or power-off state and the time without receiving NM messages reaches a predetermined time.

Furthermore, any ECU belonging to the in-vehicle network system 100, such as the power/startup management ECU 10 or the first and second normal ECUs 34, 40, may be equipped with a PNC configuration information modification unit 38 that changes the PNC configuration information assigned to each ECU 10, 34, 40. FIG. 1 shows an example where the PNC configuration information modification unit 38 is implemented in the first normal ECU 34.

The first normal ECU 34, equipped with the PNC configuration information modification unit 38, has an external communication device capable of wireless communication with an external server such as a data center 50. The first normal ECU 34 is configured to download application programs for realizing new functions in the vehicle or update programs for upgrading the programs already installed in any of the ECUs 10, 26, 30, 34, 40 from the data center 50 via the external communication device. The downloaded programs are provided to the relevant ECUs 10, 26, 30, 34, 40 via the communication bus 24, and the installation of new application programs or rewriting to update programs is executed. The ECU that communicates with the external server via the external communication device and the ECU in which the PNC configuration information modification unit 38 is implemented may be separate ECUs.

Here, depending on the functions of the application programs or update programs implemented in the ECUs 10, 26, 30, 34, 40, it may be necessary to add or change the startup conditions of the relevant ECUs. Therefore, when it is necessary to add or change the startup conditions of the ECU in which the application program or update program is implemented, the data center 50 downloads new PNC configuration information corresponding to the addition or change of the startup conditions to the first normal ECU 34 along with the application program or update program.

When the PNC configuration information modification unit 38 obtains the new PNC configuration information from the data center 50, it changes (rewrites) the PNC configuration information held by the ECUs 10, 26, 30, 34, 40 in which the application program or update program is implemented to the new PNC configuration information. As a result, the ECUs 10, 26, 30, 34, 40 in which the application program or update program is implemented are switched from the sleep state to the startup state according to the clusters indicated by the changed PNC configuration information. The rewriting of the PNC configuration information may be executed by the relevant ECU upon receiving a rewrite instruction along with the new PNC configuration information from the PNC configuration information modification unit 38. Alternatively, the rewriting of the PNC configuration information may be executed by the PNC configuration information modification unit 38 by accessing the memory of the relevant ECU.

The PNC configuration information modification unit 38 can be provided outside the in-vehicle network system 100, such as in a data center 50, instead of being implemented in an ECU belonging to the in-vehicle network system 100. However, when the PNC configuration information modification unit 38 is implemented in an ECU belonging to the in-vehicle network system 100, the PNC configuration information modification unit 38 can terminate communication with the external server once it obtains the data necessary to change the PNC configuration information of the ECU. On the other hand, if the PNC configuration information modification unit 38 is provided in an external server outside the in-vehicle network system 100, each ECU that needs to change the PNC configuration information must individually communicate with the external server via an ECU equipped with an external communication device. This may result in the disadvantage of increased communication volume with the external server.

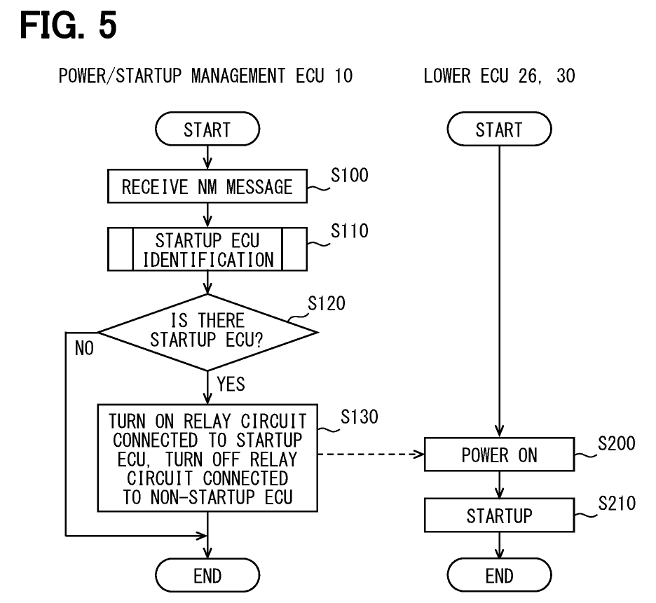

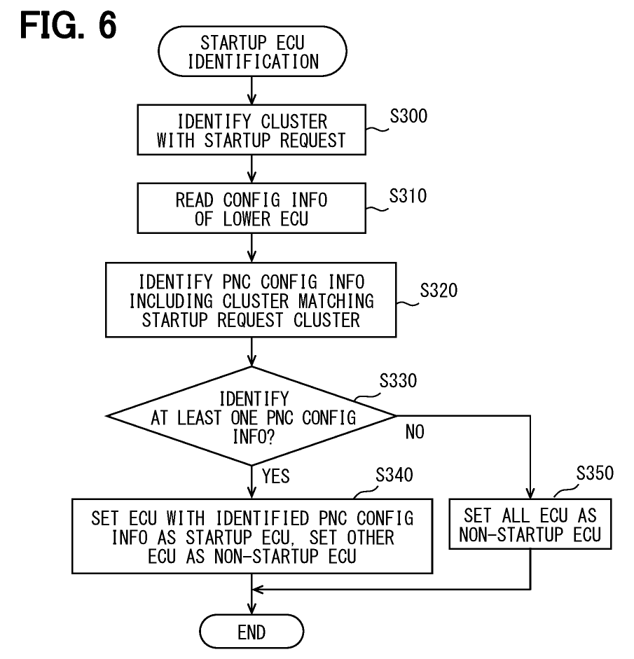

Next, with reference to the flowcharts in FIG. 5 and FIG. 6, the process executed in the power/startup management ECU 10 to subject the first and second lower ECUs 26, 30 to partial networking in response to an NM message will be described.

In step S100, the power/startup management ECU 10 receives an NM message. In step S110, the power/startup management ECU 10 executes the startup ECU identification process to identify the lower ECUs 26, 30 instructed to start by the NM message. The details of this startup ECU identification process are shown in the flowchart of FIG. 6. Hereinafter, the startup ECU identification process will be described with reference to the flowchart in FIG. 6.

In step S300, the power/startup management ECU 10 identifies the clusters requested to start based on the PN request information of the NM message. In step S310, the power/startup management ECU 10 reads the PNC configuration information of the plurality of lower ECUs 26, 30 from the storage unit 16. Then, in step S320, the power/startup management ECU 10 identifies the PNC configuration information that includes clusters matching the clusters requested to start (startup request clusters) by the PN request information.

In step S330, the power/startup management ECU 10 determines whether at least one PNC configuration information among the PNC configuration information of the plurality of lower ECUs 26, 30 includes clusters matching the startup request clusters. If at least one PNC configuration information is identified, the power/startup management ECU 10 proceeds to step S340. On the other hand, if no PNC configuration information is identified, the power/startup management ECU 10 proceeds to step S350.

In step S340, the power/startup management ECU 10 sets the lower ECUs 26, 30 corresponding to the identified PNC configuration information as startup ECUs and sets the other lower ECUs 26, 30 as non-startup ECUs. In step S350, the power/startup management ECU 10 sets all lower ECUs 26, 30 as non-startup ECUs. Thereafter, the power/startup management ECU 10 returns to the process shown in the flowchart of FIG. 5.

In step S120 of the flowchart in FIG. 5, the power/startup management ECU 10 determines whether there are any lower ECUs 26, 30 set as startup ECUs. If there are lower ECUs 26, 30 set as startup ECUs, the power/startup management ECU 10 proceeds to step S130. On the other hand, if there are no lower ECUs 26, 30 set as startup ECUs, the power/startup management ECU 10 terminates the process shown in the flowchart of FIG. 5. In this case, the NM message is discarded.

In step S130, the power/startup management ECU 10 turns on the relay circuits 18, 20 connected to the lower ECUs 26, 30 set as startup ECUs based on the relay connection information stored in the storage unit 16, which indicates the correspondence between each relay circuit 18, 20 and each lower ECU 26, 30. Additionally, the power/startup management ECU 10 turns off the relay circuits 18, 20 connected to the lower ECUs 26, 30 set as non-startup ECUs.

As shown in step S200 of the flowchart in FIG. 5, the lower ECUs 26, 30 with the relay circuits 18, 20 turned on start receiving power. As a result, the lower ECUs 26, 30 with the relay circuits 18, 20 turned on undergo predetermined processing for startup in step S210 and enter the startup state.

As described above, according to the in-vehicle network system 100 of the present embodiment, the power/startup management ECU 10 receives NM messages that selectively instruct the startup of the plurality of lower ECUs 26, 30 on behalf of the plurality of lower ECUs 26, 30 via the communication bus 24. The power/startup management ECU 10 then turns on the relay circuits 18, 20 connected to the lower ECUs 26, 30 instructed to start by the NM message. As a result, the lower ECUs 26, 30 instructed to start enter the startup state. Therefore, according to the in-vehicle network system 100 of the present embodiment, it is possible to finely manage the supply and stop of power to the lower ECUs 26, 30 while configuring the system to switch the power supply to the lower ECUs 26, 30 from the stopped state to the supply state in response to the NM message instructing startup.

### Second Embodiment

A second embodiment of the in-vehicle network system 100 and the control method for the in-vehicle network system 100 according to the present disclosure will be described. In this embodiment, the in-vehicle network system 100 is configured similarly to the in-vehicle network system 100 of the first embodiment, so the description of the configuration will be omitted.

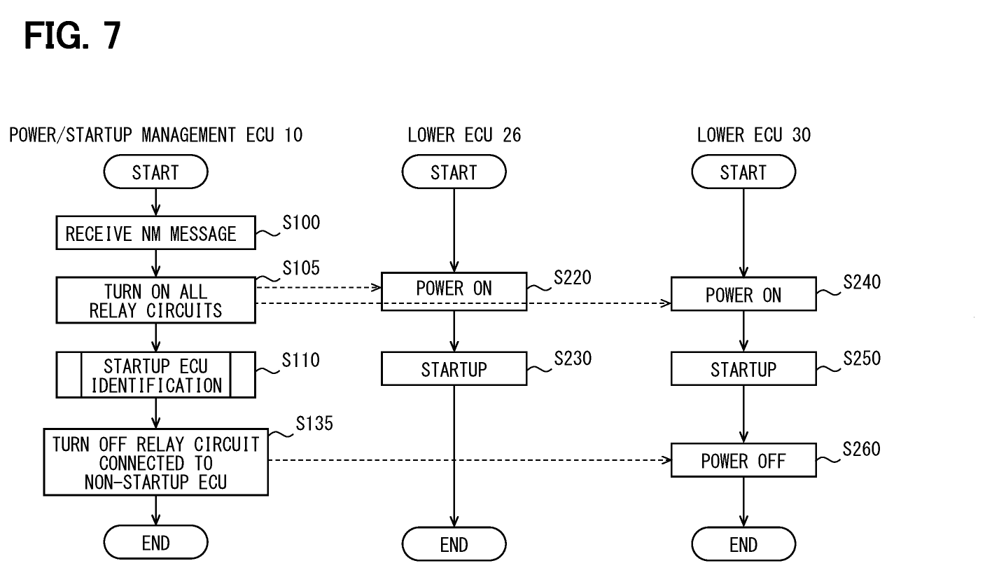

FIG. 7 is a flowchart showing the process executed in the power/startup management ECU 10 to subject the first and second lower ECUs 26, 30 to partial networking in response to an NM message according to the present embodiment.

In step S100, similar to the flowchart in FIG. 5, the power/startup management ECU 10 receives an NM message. However, in this embodiment, before executing the startup ECU identification process in step S110, the power/startup management ECU 10 turns on all relay circuits 18, 20 in step S105. As a result, all lower ECUs 26, 30 start receiving power as shown in steps S220 and S240 of the flowchart in FIG. 7. Then, all lower ECUs 26, 30 undergo predetermined processing for startup in steps S230 and S250 and enter the startup state.

After executing the startup ECU identification process in step S110, the power/startup management ECU 10 turns off the relay circuits 18, 20 connected to the lower ECUs 26, 30 set as non-startup ECUs in step S135. As a result, the lower ECUs 26, 30 with the relay circuits 18, 20 turned off stop receiving power as shown in step S260 of the flowchart in FIG. 7.

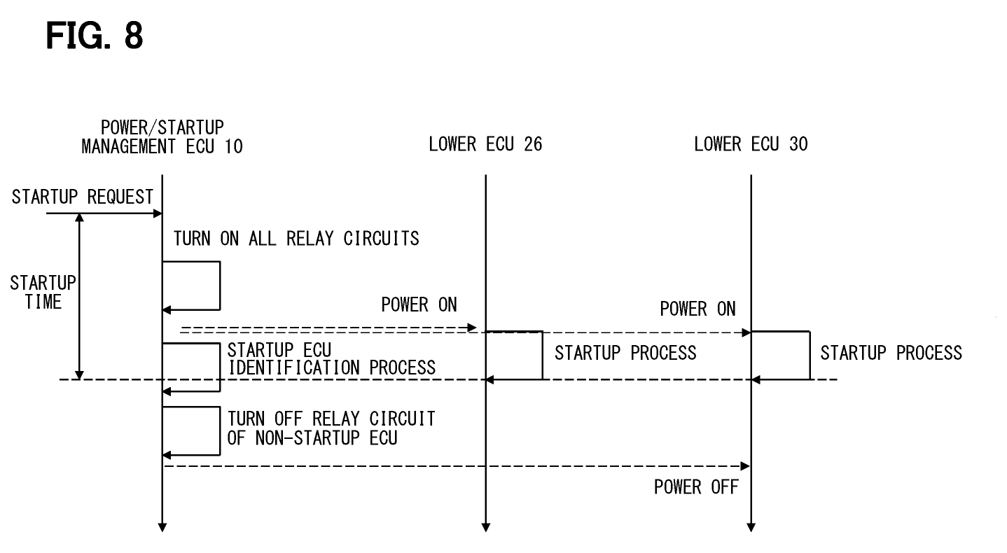

As described above, in this embodiment, when the power/startup management ECU 10 receives an NM message that selectively instructs the startup of the lower ECUs 26, 30, it executes the process of turning on all relay circuits 18, 20 as shown in the sequence diagram of FIG. 8. This allows the lower ECUs 26, 30 to enter the startup state earlier compared to the case where the lower ECUs 26, 30 corresponding to the startup ECUs are started after executing the startup ECU identification process. Additionally, as shown in the sequence diagram of FIG. 8, the power/startup management ECU 10 immediately executes the process of turning off the relay circuits 18, 20 connected to the lower ECUs 26, 30 set as non-startup ECUs after the startup ECU identification process. Therefore, the in-vehicle network system 100 according to the present embodiment can suppress power consumption by the lower ECUs 26, 30 corresponding to the non-startup ECUs.

### Third Embodiment

A third embodiment of the in-vehicle network system 100 and the control method for the in-vehicle network system 100 according to the present disclosure will be described.

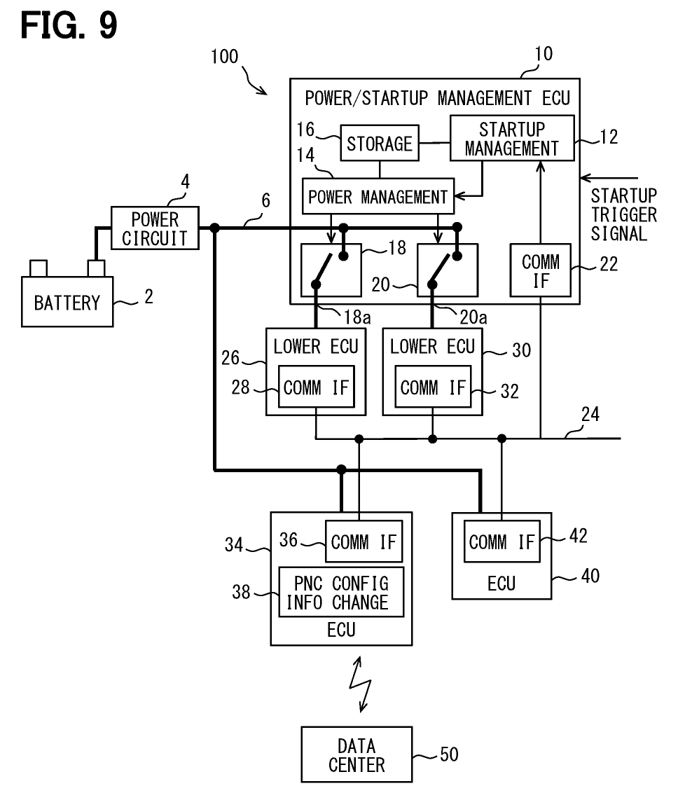

FIG. 9 is a configuration diagram showing the configuration of the in-vehicle network system 100 according to the present embodiment. The in-vehicle network system 100 according to the present embodiment has the same configuration as the in-vehicle network system 100 according to the first embodiment. Therefore, the in-vehicle network system 100 according to the present embodiment can achieve the same effects as the in-vehicle network system 100 according to the first embodiment. In addition, the in-vehicle network system 100 according to the present embodiment is configured such that a startup trigger signal for starting either the first or second lower ECU 26, 30 is input to the power/startup management ECU 10.

For example, among the first and second lower ECUs 26, 30, there may be lower ECUs 26, 30 that need to be started using a detection signal from a sensor, an operation signal from a switch operated by a user, or an operation signal by operation of an actuator as the startup trigger signal. However, since the first and second lower ECUs 26, 30 are in a power-off state before being switched to the startup state, they cannot enter the startup state by the startup trigger signal.

Therefore, in the in-vehicle network system 100 according to the present embodiment, a startup trigger signal for starting at least one of the lower ECUs 26, 30, which is generated when a predetermined startup condition is met, is input to the power/startup management ECU 10. The power/startup management ECU 10 turns on the relay circuits 18, 20 corresponding to at least one of the lower ECUs 26, 30 that should be in the startup state in response to the input of the startup trigger signal. As a result, the lower ECUs 26, 30 that should be started can be switched to the startup state in response to the generation of the startup trigger signal.

It is preferable that the power/startup management ECU 10 stores the correspondence between the startup trigger signal and the lower ECUs 26, 30 that should be in the startup state in the storage unit 16. This allows the power/startup management ECU 10 to determine which lower ECUs 26, 30 should be started when the startup trigger signal is input by referring to the correspondence stored in the storage unit 16. If there are multiple types of startup trigger signals input to the power/startup management ECU 10, and the lower ECUs 26, 30 that should be in the startup state differ depending on the types of startup trigger signals, storing the aforementioned correspondence is particularly useful.

Furthermore, the lower ECUs 26, 30 that are switched to the startup state in response to the input of the startup trigger signal to the power/startup management ECU 10 are not necessarily limited to one. For example, if the first lower ECU 26 and the second lower ECU 30 belong to a common cluster, the other lower ECU 26, 30 will also be started in response to the startup of one of the lower ECUs 26, 30. In such cases, the storage unit 16 may store not only the lower ECUs 26, 30 that should be started by the startup trigger signal but also the lower ECUs 26, 30 belonging to the common cluster as the correspondence between the startup trigger signal and the lower ECUs 26, 30 that should be in the startup state. This allows all lower ECUs 26, 30 that should be started by the startup trigger signal to be switched to the startup state almost simultaneously.

Additionally, similar to the case of the NM message, the power/startup management ECU 10 may turn on all relay circuits 18, 20 in response to the input of the startup trigger signal. Thereafter, the power/startup management ECU 10 identifies the lower ECUs 26, 30 that should be started in response to the input of the startup trigger signal by referring to the correspondence stored in the storage unit 16. The power/startup management ECU 10 then keeps the relay circuits 18, 20 connected to the lower ECUs 26, 30 identified as startup ECUs turned on and switches the relay circuits 18, 20 connected to the lower ECUs 26, 30 identified as non-startup ECUs from on to off. This allows the lower ECUs 26, 30 to be switched to the startup state early in response to the startup trigger signal.

### Modifications

The system and method described in the present disclosure may be implemented by a dedicated computer configured with a processor programmed to execute one or more functions embodied by a computer program. The system and method described in the present disclosure may also be implemented using dedicated hardware logic circuits. Furthermore, the system and method described in the present disclosure may be implemented by one or more dedicated computers configured with a combination of a processor executing a computer program and one or more hardware logic circuits. For example, part or all of the functions provided by the power/startup management ECU 10 may be implemented as hardware. The embodiments for implementing a function as hardware include using one or more ICs (Integrated Circuits). Part or all of the functions provided by the power/startup management ECU 10 may be implemented using a System-on-Chip (SoC), IC, or Field-Programmable Gate Array (FPGA). The concept of IC includes Application Specific Integrated Circuits (ASICs) as well. Additionally, the computer program may be stored as instructions executable by a computer on a non-transitory tangible storage medium. As recording media for the program, HDDs (Hard-disk Drives), SSDs (Solid State Drives), flash memory, and the like can be employed. Moreover, the form of a program for making a computer function as the power/startup management ECU 10, and non-transitory tangible storage media such as semiconductor memory storing this program, are also within the scope of the present disclosure.

In the present disclosure, the phrase "at least one of a circuit and a processor" should be interpreted disjunctively (logical OR) and should not be interpreted as at least one circuit and at least one processor. Therefore, in the present disclosure, "at least one of a circuit and a processor is configured to cause an upper control device to execute functions" includes the case where only the circuit causes an upper control device to execute all the functions. Additionally, "at least one of a circuit and a processor is configured to cause an upper control device to execute functions" includes the case where only the processor causes an upper control device to execute all the functions. Furthermore, "at least one of a circuit and a processor is configured to cause an upper control device to execute functions" includes the case where the circuit causes an upper control device to execute some of the functions and the processor causes an upper control device to execute the remaining functions. In the last case, for instance, if an upper control device executes functions A to C, functions A and B may be implemented by the circuit, and the remaining function C may be implemented by the processor.

What is claimed is:

1. An in-vehicle network system comprising:
a plurality of control devices connected to a communication bus and capable of communicating with each other in a vehicle,
wherein
the plurality of control devices include at least one upper control device and a plurality of lower control devices,
the upper control device includes:
at least one of (i) a circuit and (ii) a processor with a memory storing computer program code executable by the processor, the at least one of the circuit and the processor configured to cause the upper control device to:
turn on and off a plurality of relay circuits provided in a power supply line of each of the plurality of lower control devices; and
receive, on behalf of the plurality of lower control devices, a network management message (NM message) that selectively instructs a startup of the plurality of lower control devices transmitted via the communication bus, and instructs to turn on a relay circuit provided in the power supply line of the lower control device instructed to start by the NM message, to bring the lower control device instructed to start into a startup state.

2. The in-vehicle network system according to claim 1, wherein
the NM message includes startup cluster information that designates a startup cluster indicating a group of the control device to be started,
the upper control device includes a storage unit that stores cluster configuration information indicating a cluster to which the lower control device belongs for each of the plurality of lower control devices, and
the at least one of the circuit and the processor configured to cause the upper control device to determine that the startup of the lower control device corresponding to the relevant cluster configuration information is instructed by the NM message when the startup cluster designated by the startup cluster information of the NM message matches the cluster in the cluster configuration information.

3. The in-vehicle network system according to claim 2, further comprising
a modification unit capable of changing the cluster configuration information of each of the plurality of lower control devices stored by the upper control device.

4. The in-vehicle network system according to claim 3, wherein
the modification unit is implemented in any of the plurality of control devices connected to the communication bus.

5. The in-vehicle network system according to claim 2, wherein
the upper control device includes a storage unit that stores the cluster configuration information of each of the plurality of lower control devices and relay connection information indicating a correspondence between the plurality of lower control devices and the plurality of relay circuits.

6. The in-vehicle network system according to claim 5, wherein
the upper control device turns on the relay circuit corresponding to the lower control device whose cluster matches the startup cluster designated by the startup cluster information included in the NM message based on the cluster configuration information and the relay connection information, and turns off the relay circuit corresponding to the lower control device whose cluster does not match.

7. The in-vehicle network system according to claim 6, wherein
the upper control device, upon receiving the NM message, turns on all the relay circuits to bring all the lower control devices into a startup state before determining the match between the startup cluster designated by the startup cluster information and the cluster in the cluster configuration information of each of the plurality of lower control devices, and then
the upper control device determines the match between the startup cluster designated by the startup cluster information and the cluster in the cluster configuration information of each of the plurality of lower control devices, and
the upper control device keeps the relay circuit corresponding to the lower control device whose cluster matches the startup cluster designated by the startup cluster information on, and switches the relay circuit corresponding to the lower control device whose cluster does not match from on to off.

8. The in-vehicle network system according to claim 1, wherein
at least one of the plurality of lower control devices is to be brought into a startup state when a predetermined startup condition is met,
a startup trigger signal generated when the predetermined startup condition is met is input to the upper control device, and
the upper control device turns on the relay circuit corresponding to at least one of the plurality of lower control devices to be brought into the startup state in response to the input of the startup trigger signal.

9. The in-vehicle network system according to claim 8, wherein
the upper control device includes a storage unit that stores the lower control device to be brought into the startup state based on the startup trigger signal, and
the relay circuit corresponding to the stored lower control device is turned on in response to the input of the startup trigger signal.

10. The in-vehicle network system according to claim 9, wherein
the upper control device, in response to the input of the startup trigger signal, turns on all the relay circuits to bring all the lower control devices into a startup state, and then keeps the relay circuit corresponding to the stored lower control device on, and switches the relay circuit corresponding to the unstored lower control device from on to off.

11. A control method for an in-vehicle network system including a plurality of control devices connected to a communication bus and capable of communicating with each other in a vehicle, wherein the plurality of control devices include at least one upper control device and a plurality of lower control devices, the upper control device includes a power management unit that turns on and off a plurality of relay circuits provided in a power supply line of each of the plurality of lower control devices, the method comprising:
receiving, by the upper control device, on behalf of the plurality of lower control devices, a network management message (NM message) that selectively instructs a startup of the plurality of lower control devices transmitted via the communication bus; and
bringing the lower control device instructed to start into a startup state by turning on the relay circuit provided in the power supply line of the lower control device instructed to start by the NM message.
